(19) United States
(12) Patent Application Publication
(10) Pub. No.: US 2024/0379266 A1
(43) Pub. Date: Nov. 14, 2024

(54) COIL ELECTRONIC COMPONENT

(71) Applicant: SAMSUNG ELECTRO-MECHANICS CO., LTD., Suwon-si (KR)

(72) Inventor: So Young Jun, Suwon-si (KR)

(73) Assignee: SAMSUNG ELECTRO-MECHANICS CO., LTD., Suwon-si (KR)

(21) Appl. No.: 18/589,794

(22) Filed: Feb. 28, 2024

(30) Foreign Application Priority Data
May 10, 2023 (KR) 10-2023-0060273

(51) Int. Cl. H01F 5/04; H01F 27/28

(52) U.S. Cl. CPC H01F 5/04; H01F 27/2852

(57) ABSTRACT

A disclosed coil electronic component includes: a main body that includes a first and a second surface opposing each other, a third surface and a fourth surface opposing each other, and a fifth surface and a sixth surface opposing each other, and includes a magnetic material; a coil disposed inside the main body; a first external electrode and a second external electrode that are disposed at a distance from each other on the fifth surface or the sixth surface of the main body and respectively connected to opposite ends of the coil; and an insulating layer that covers at least a portion of the fifth surface or sixth surface of the main body between the first external electrode and the second external electrode. A thickness of the insulating layer may be greater than 1 μm and smaller than 10 μm.

### CROSS-REFERENCE TO RELATED APPLICATION

This application claims priority to and the benefit of Korean Patent Application No. 10-2023-0060273 filed in the Korean Intellectual Property Office on May 10, 2023, the entire contents of which are incorporated herein by reference.

### TECHNICAL FIELD

The present disclosure relates to a coil electronic component.

### BACKGROUND

Recently, as functions of a mobile device diversify, power consumption increases, and passive components with low loss and excellent efficiency are adopted at the periphery of a power semiconductor (power management integrated circuit, PMIC) to increase battery usage time in the mobile device. Meanwhile, the demand for a low-profile power inductor is increasing in order to slim the product and increase the degree of freedom of component arrangement.

There is a case where an external electrode of the power inductor is formed with silver (Ag)-epoxy. In this case, the external electrode may be peeled off by external impact due to low adhesion strength. Meanwhile, when the area where the external electrode is formed on a surface of a main body of a coil electronic component is widened to increase the adhesion strength of the external electrode, there is a risk that the separation distance between the external electrodes are too close and cause a short circuit.

On the other hand, when an insulating layer is formed thinly on an outer surface of the main body of the power inductor, cracks may occur in the insulating layer due to irregularities on the outer surface, resulting in moisture penetration.

### SUMMARY

One aspect of an embodiment is to provide a coil electronic component with a reduced rate of shorts.

Another aspect of the embodiment is to provide a coil electronic component with improved adhesion strength of an external electrode.

Still another aspect of the embodiment is to provide a coil electronic component that can prevent occurrence of cracks in an insulating layer and subsequent penetration of moisture.

However, the problem to be solved by the present embodiment is not limited to the above-described problem and may be variously expanded in the range of technical ideas included in the present embodiment.

A coil electronic component according to an embodiment includes: a main body that includes a first surface and a second surface opposing each other in a first direction, a third surface and a fourth surface connecting the first surface and the second surface and opposing each other in a second direction, and a fifth surface and a sixth surface connecting the first surface and the second surface and opposing each other in a third direction, and includes a magnetic material; a coil disposed inside the main body; a first external electrode and a second external electrode that are disposed at a distance from each other on the fifth surface or the sixth surface of the main body and respectively connected to opposite ends of the coil; and an insulating layer that covers at least a portion of the fifth surface or sixth surface of the main body between the first external electrode and the second external electrode. A thickness of the insulating layer may be greater than 1 μm and smaller than 10 μm.

In addition, a thickness of the first and second external electrodes may be larger than the thickness of the insulating layer, and the difference in thickness therebetween may be 5 μm or more and 15 μm or less.

In addition, a separation distance between the first external electrode and the second external electrode along the first direction may be 45% or more and 70% or less of a length of the coil electronic component.

In addition, irregularities may exist on the fifth surface or the sixth surface where the first external electrode and the second external electrode are disposed.

In addition, each of the first external electrode and the second external electrode may include a first electrode layer that is in contact with the fifth surface or the sixth surface of the main body, a second electrode layer that covers the first electrode layer, and a third electrode layer that covers the second electrode layer.

In addition, the first electrode layer may contain copper (Cu).

In addition, the first electrode layer may be a conductive resin layer.

In addition, the first external electrode may be connected with the coil on the first surface, and extend to the fifth surface or the sixth surface, and the second external electrode may be connected with the coil on the second surface, and extend to the fifth surface or the sixth surface.

In addition, the first external electrode may be connected with the coil on the first surface, and extend to the fifth surface and the sixth surface and, the second external electrode may be connected with the coil on the second surface, and extend to the fifth surface and the sixth surface.

In addition, the first external electrode may be connected with the coil on the first surface, and extend to the third surface, the fourth surface, the fifth surface, and the sixth surface, and the second external electrode may be connected with the coil on the second surface, and extend to the third surface, the fourth surface, the fifth surface, and the sixth surface.

In addition, the coil electronic component may further include a support substrate that includes a first support surface and a second support surface disposed inside the main body and opposing each other, wherein the coil may include a first coil disposed on the first support surface of the support substrate, a second coil disposed on the second support surface of the support substrate, and a via through the support substrate and connecting the first coil and the second coil.

In addition, in the coil electronic component, the main body may be a laminate made by stacking a plurality of sheets, and the coil may include a plurality of internal electrodes that is disposed on each sheet of the plurality of sheets and connected to each other.

In addition, in the coil electronic component, the coil may be a wound coil.

In addition, the wound-type coil may extend toward the fifth surface or the sixth surface and a lead terminal of the wound coil is connected to the first external electrode and the second external electrode.

In the coil electronic component according to the embodiment, a shorting rate can be reduced by setting a ratio of a separation distance between the external electrodes to the length of the coil electronic component to a certain range.

In addition, in the coil electronic component according to the embodiment, by forming irregularities on the surface of the main body, the bonding strength between the plating layer of the external electrode and the surface of the main body can be strengthened to increase the adhesion strength of the external electrode.

In addition, in the coil electronic component according to the embodiment, by limiting the thickness of the insulating layer to a certain range, the possibility of cracking in the insulating layer and consequent moisture penetration may be reduced.

### BRIEF DESCRIPTION OF THE DRAWINGS

FIG. 1 is a schematic perspective view of a coil electronic component according to an embodiment.

FIG. 2 is a cross-sectional view taken along line II-II′ of FIG. 1.

FIG. 3 is an enlarged view of the region S1 of FIG. 2.

FIG. 4 is an enlarged view of the region S2 of FIG. 2.

FIG. 5 is a schematic cross-sectional view of the coil electronic component of FIG. 1 mounted on a circuit substrate.

FIG. 6 is a schematic perspective view of a coil electronic component according to another embodiment.

FIG. 7 is a schematic perspective view of a coil electronic component according to another embodiment.

FIG. 8 is a schematic perspective view of a coil electronic component according to another embodiment.

FIG. 9 is a schematic cross-sectional view of a coil electronic component according to another embodiment.

FIG. 10 is a schematic cross-sectional view of a coil electronic component according to another embodiment.

FIG. 11 is a schematic cross-sectional view of a coil electronic component according to another embodiment.

### DETAILED DESCRIPTION OF THE EMBODIMENTS

Hereinafter, with reference to accompanying drawings, an embodiment of the present disclosure will be described in detail such that a person of an ordinary skill can easily practice it in the technical field to which the present disclosure belongs. The drawings and description are to be regarded as illustrative in nature and not restrictive. Like reference numerals designate like elements throughout the specification. In addition, in the accompanying drawing, some constituent elements are exaggerated, omitted, or schematically shown, and the size of each constituent element does not fully reflect the actual size.

The accompanying drawings are only for easy understanding of the embodiments disclosed in this specification, and the technical ideas disclosed in this specification are not limited by the accompanying drawings, and it should be understood to include all changes and equivalents or substitutes included in the spirit and technical range of the present disclosure.

Terms containing ordinal numbers, such as first, second, and the like can be used to describe various configurations elements, but the constituent elements are not limited by the terms. The terms are used only for the purpose of distinguishing one constituent element from another.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, throughout the specification, the word “on” a target element will be understood to mean positioned above or below the target element, and will not necessarily be understood to mean positioned “at an upper side” based on an opposite to gravity direction.

Throughout the specification, terms such as “comprise” or “have” are intended to designate that a feature, number, step, operation, constituent element, part, or combination thereof described in the specification exists, and it should be understood as not precluding the possibility of the presence or addition of and one or more other features, numbers, steps, actions, constituent elements, parts, or combinations thereof. In addition, unless explicitly described to the contrary, the word “comprise” and variations such as “comprises” or “comprising” will be understood to imply the inclusion of stated elements but not the exclusion of any other elements.

Further, throughout the specification, the phrase “on a plane” means viewing a target portion from the top, and the phrase “on a cross-section” means viewing a cross-section formed by vertically cutting a target portion from the side.

Throughout the specification, “connected” does not mean only when two or more constituent elements are directly connected, but also when two or more constituent elements are indirectly connected through another constituent element, or when physically connected or electrically connected, and it may include a case in which substantially integral parts are connected to each other although they are referred to by different names according to positions or functions.

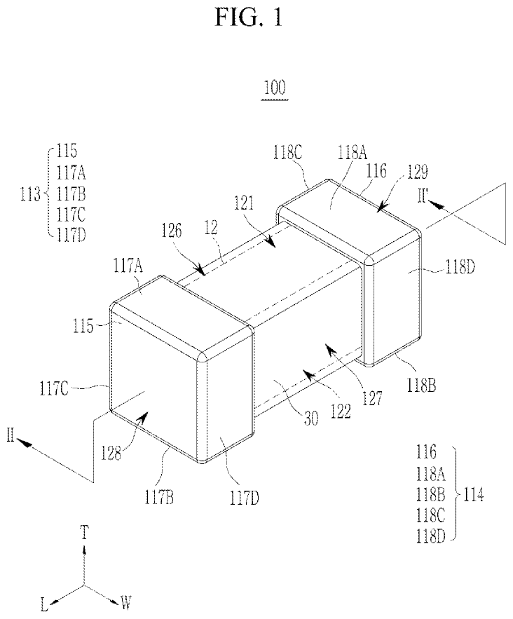

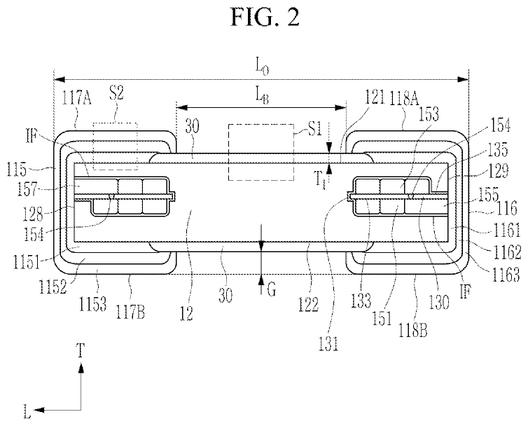

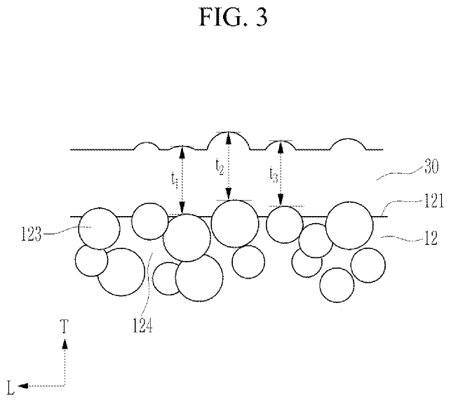

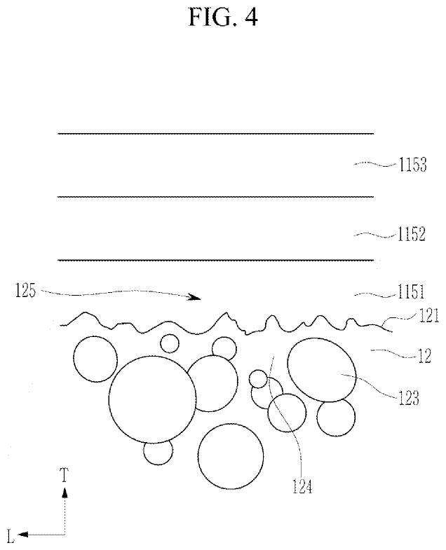

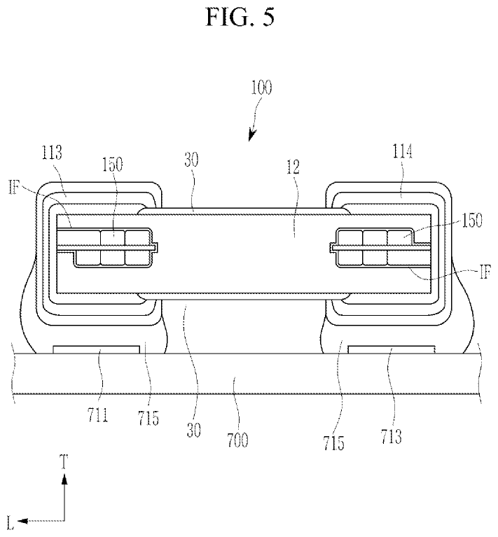

FIG. 1 is a schematic perspective view of a coil electronic component according to an embodiment, FIG. 2 is a cross-sectional view taken along line II-II′ of FIG. 1, FIG. 3 is an enlarged view of the region S1 of FIG. 2, FIG. 4 is an enlarged view of the region S2 of FIG. 2, and FIG. 5 is a schematic cross-sectional view of the coil electronic component of FIG. 1 mounted on a circuit substrate.

Referring to FIG. 1 to FIG. 5, a coil electronic component 100 according to an embodiment includes a main body 12, a support substrate 130, a coil 150, a first external electrode 113, a second external electrode 114, and an insulating layer 30.

The main body 12 includes a magnetic material and may comprise magnetic particles 123 and an insulating resin 124 interposed between the magnetic particles 123.

The magnetic particles may be ferrite particles or metallic magnetic particles exhibiting magnetic properties.

The ferrite particle may be at least one or more of, for example, spinel type ferrites such as Mg—Zn-based, Mn—Zn-based, Mn—Mg-based, Cu—Zn-based, Mg—Mn—Sr-based, Ni—Zn-based, etc., hexagonal ferrites such as Ba—Zn-based, Ba—Mg-based, Ba—Ni-based, Ba—Co-based, and Ba—Ni—Co-based, etc., and garnet-type ferrite such as Y-based, and Li-based ferrite.

The metallic magnetic particle may contain one or more selected from the group consisting of iron (Fe), silicon (Si), chromium (Cr), cobalt (Co), molybdenum (Mo), aluminum (Al) niobium (Nb), copper (Cu), and nickel (Ni). For example, the metallic magnetic particle may be at least one or more of pure iron, a Fe—Si alloy, a Fe—Si—Al alloy, a Fe—Ni alloy, a Fe—Ni—Mo alloy, a Fe—Ni—Mo—Cu alloy, a Fe—Co alloy, a Fe—Ni—Co alloy, a Fe—Cr alloy, a Fe—Cr—Si alloy, a Fe—Si—Cu—Nb alloy, a Fe—Ni—Cr alloy, and a Fe—Cr—Al alloy.

The metallic magnetic particles may be amorphous or crystalline. For example, the metallic magnetic particle may be an Fe—Si—B—Cr based amorphous alloy, but the present embodiment is not limited thereto. The metallic magnetic particles may have an average diameter of about 0.1 μm to about 30 μm, but is not limited thereto. In the present specification, the particle diameter or average diameter may mean a particle size distribution expressed as D₉₀ or D₅₀.

The metallic magnetic particles may be two or more types of different metallic magnetic particles. Here, the different types of metallic magnetic particles mean that the metallic magnetic particles are distinguished from each other in at least one of average diameter, composition, component ratio, crystallinity, and shape.

The insulating resin may include, but is not limited to, epoxy, polyimide, liquid crystalline polymer, and the like, either alone or in combination.

The main body 12 may have an approximately hexahedral shape, but the present embodiment is not limited thereto. Due to shrinkage of magnetic powder during sintering, the main body 12 may have a substantially hexahedral shape, although it is not a perfect hexahedral shape. For example, the main body 12 has a roughly rectangular hexahedral shape, but the corner or vertex portion may be rounded.

In the present embodiment, for convenience of description, two surfaces opposing each other in a thickness direction (T-axis direction) will be defined as a first surface 121 and a second surface 122, respectively, two surfaces opposing each other in a width direction (W-axis direction) will be defined as a first side surface 126 and a second side surface 127, respectively, and two surfaces opposing each other in a length direction (L-axis direction) will be defined as a first end surface 128 and a second end surface 129, respectively.

A length of the coil electronic component 100 is measured on the basis of an optical microscope or scanning electron microscope (SEM) image of a cross section taken in the length direction (L-axis direction)-thickness direction (T-axis direction) at a central portion of the coil electronic component 100 in the width direction (W-axis direction). The length of the coil electronic component 100 may mean a maximum value among lengths of a plurality of line segments that connect the two outermost boundary lines, which are opposite to each other in the length direction (L-axis direction) of the coil electronic component 100 shown in the above-mentioned cross-sectional image and are parallel to the length direction (L-axis direction). Alternatively, the length of the coil electronic component 100 may mean a minimum value among lengths of a plurality of line segments that connect the two outermost boundary lines, which are opposite to each other in the length direction (L-axis direction) of the coil electronic component 100 shown in the aforementioned cross-sectional image and are parallel to the length direction (L-axis direction). Alternatively, the length of the coil electronic component 100 may mean an arithmetic mean value of the lengths of at least two line segments among the plurality of line segments that connect the two outermost boundary lines, which are opposite to each other in the length direction (L-axis direction) of the coil electronic component 100 shown in the above-mentioned cross-sectional image and are parallel to the length direction (L-axis direction).

A thickness of the coil electronic component 100 is measured on the basis of an optical microscope or scanning electron microscope (SEM) image of a cross-section (taken in the length direction (L-axis direction)-thickness direction (T-axis direction)) at a central portion of the coil electronic component 100 in the in the width direction (W-axis direction). The thickness of the coil electronic component 100 may mean a maximum value among lengths of a plurality of line segments that connect the two outermost boundary lines, which are opposite to each other in the thickness direction (T-axis direction) of the coil electronic component 100 shown in the above-described cross-sectional image and are parallel to the thickness direction (T-axis direction). Alternatively, the thickness of the coil electronic component 100 may mean a minimum value among the lengths of a plurality of line segments that connect the two outermost boundary lines, which are opposite to each other in the thickness direction (T-axis direction) of the coil electronic component 100 shown in the above-mentioned cross-sectional image and are parallel to the thickness direction (T-axis direction). Alternatively, the thickness of the coil electronic component 100 may mean an arithmetic mean value of the lengths of at least two line segments among the plurality of line segments that connect the two outermost boundary lines, which are opposite to each other in the thickness direction (T-axis direction) of the coil electronic component 100 shown in the above-mentioned cross-sectional image and are parallel to the thickness direction (T-axis direction).

A width of the coil electronic component 100 is measured on the basis of an optical microscope or scanning electron microscope (SEM) image of a cross-section (taken in the length direction (L-axis direction)-width direction (W-axis direction) at a central portion of the coil electronic component 100 in the thickness direction (T-axis direction). The width of the coil electronic component 100 may mean a maximum value along lengths of a plurality of line segments that connect the two outermost boundary lines, which are opposite to each other in the width direction (W-axis direction) of the coil electronic component 100 shown in the above-described cross-section image and are parallel to the width direction (W-axis direction). Alternatively, the width of the coil electronic component 100 may mean a minimum value among the lengths of a plurality of line segments that connect two outermost boundary lines, which are opposite to each other in the width direction (W-axis direction) of the coil electronic component 100 shown in the above-mentioned cross-sectional image and are parallel to the width direction (W-axis direction). Alternatively, the width of the coil electronic component 100 may mean an arithmetic mean value of the lengths of at least two line segments among a plurality of line segments that connect the two outermost boundary lines, which are opposite to each other in the width direction (W-axis direction) of the coil electronic component 100 shown in the above-mentioned cross-sectional image and are parallel to the width direction (W-axis direction).

Meanwhile, each of the length, width, and thickness of the coil electronic component 100 may be measured in a micrometer measurement method. The micrometer measurement method may be performed by setting a zero point by using Gage R&R (repeatability and reproducibility), inserting the coil electronic component 100 according to the present embodiment between tips of the micrometer, and rotating a measurement lever of the micrometer. Meanwhile, when measuring the length of the coil electronic component 100 by using the micrometer measurement method, the length of the coil electronic component 100 may mean a value measured once or may mean an arithmetic mean of values measured multiple times. The same may also apply to the measurement of the width and thickness of the coil electronic component 100.

The support substrate 130 is disposed inside the main body 100 and supports the coil 150.

The support substrate 130 may be made of an insulating material including a thermosetting insulating resin such as epoxy resin, a thermoplastic insulating resin such as polyimide, or a photosensitive insulating resin, or an insulating material impregnated with a reinforcing member such as glass fiber or inorganic filler. For example, the support substrate 130 may be made of an insulating material such as prepreg, an Ajinomoto build-up film (ABF), FR-4, a bismaleimide triazine (BT) film, a photo imageable dielectric (PID) film, and the like, but the present embodiment is not limited thereto.

Inorganic fillers may include at least one selected from the group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃).

A through-hole 131 is at the center of the support substrate 130. The through-hole 131 may be filled with magnetic material that comprises the main body 12 to form a core, thereby improving the performance of the coil electronic component.

The coil 150 is disposed inside the main body 12, thereby exhibiting characteristics of the coil electronic component 100. For example, when the coil electronic component 100 according to the present embodiment is utilized as a power inductor, the coil 150 may serve to stabilize the power of the electronic device by storing an electric field as a magnetic field and maintaining the output voltage.

The coil 150 may be disposed on a lower surface 133 and an upper surface 135 of the support substrate 130 opposing each other. The coil 150 includes a first coil 151 and a second coil 153, and the first coil 151 and the second coil 153 may be electrically connected to each other via a via 154.

The first coil 151 is disposed on the lower surface 133 of the support substrate 130 and connected to a first lead terminal 155. The first lead terminal 155 is exposed from the second end surface 129 of the main body 12 and is electrically connected to a second external electrode 114.

The second coil 153 is disposed on the upper surface 135 of the support substrate 130 and connected to second lead terminal 157. The second lead terminal 157 is exposed from the first end surface 128 of the main body 12 and is electrically connected to the first external electrode 113.

Meanwhile, when the first coil 151, the first lead terminal 155, and the via 154 are plated on the lower surface 133 of the support substrate 130, the first coil 151, the first lead terminal 155, and the via 154 each may include a seed layer such as an electroless plating layer and an electrolytic plating layer. Here, the electroplating layer may have a single-layer structure or a multi-layered structure. The multi-layered electroplating layer may be formed as a conformal film structure with one electroplating layer covering the other, or as a stacked structure with one electroplating layer stacked only on one side of the other. A seed layer of the first coil 151, a seed layer of the first lead terminal 155, and a seed layer of the via 154 may be integrally formed and thus there may be no interface therebetween, but the present embodiment is not limited thereto. An electroplating layer of the first coil 151, and electroplating layer of the first lead terminal 155, and an electroplating layer of the via 154 may be integrally formed and thus there may be no interface therebetween, but the present embodiment is not limited thereto. The above description may be equally applied to the second coil 153, the second lead terminal 157, and the via 154.

The coil 150 and the via 154 each may be made of a conductive material such as copper (Cu), aluminum (Al), silver (Ag), tin (Sn), gold (Au), nickel (Ni), lead (Pb), titanium (Ti), or an alloy thereof, but the present embodiment is not limited thereto.

An insulating film IF may be disposed between the coil 150 and the main body 12. The insulating film IF may be formed along surfaces of the support substrate 130 and the coil 150. No insulating film IF is present where the support substrate 130 and the coil 150 are connected to the external electrodes 115 and 116. The insulating film IF insulates the coil 150 from the main body 12, and may include a known insulating material such as parylene, but is not limited thereto. The insulating film IF may be formed by a method such as vapor deposition, but is not limited thereto. For example, the insulating film IF may be formed by laminating insulating films on both sides of the support substrate 130.

The first and second external electrodes 113 and 114 are disposed outside the main body 12 and connected to the coil 150. That is, the first external electrode 113 is connected to the second lead terminal 157 of the coil 150, and the second external electrode 114 is connected to the first lead terminal 155 of the coil 150.

The first external electrode 113 is connected to the second lead terminal 157 of the coil 150 on the first end surface 128 of the main body 12, and extends to the first surface 121, the second surface 122, the first side surface 126, and the second side surface 127.

The second external electrode 114 is connected to the first lead terminal 155 of the coil 150 on the second end surface 129 of the main body 12, and extends to the first surface 121, the second surface 122, the first side surface 126, and the second side surface 127.

For example, the first and second external electrodes 113 and 114 are disposed at opposite ends of the length direction (L-axis direction) of the main body 12, and may include a first main portion 115, a second main portion 116, first band portions 117A, 117B, 117C, and 117D, and second band portions 118A, 118B, 118C, and 118D, respectively.

The first main portion 115 is a portion that covers the first end surface 128 of the main body 12 and is electrically connected to the second lead terminal 157 of the second coil 153.

The second main portion 116 is a portion that covers the second end surface 129 of the main body 12 and is electrically connected to the first lead terminal 155 of the first coil 151.

The first band portions 117A, 117B, 117C, and 117D may extend along the length direction (L-axis direction) of the main body 12 from the first main portion 115 and may cover portions of the first and second surfaces 121 and 122 and portions of the first and second side surfaces 126 and 127 of the main body 12.

The second band portions 118A, 118B, 118C, and 118D extend along the length direction (L-axis direction) of the main body 12 from the second main portion 116 and may cover portions of the first surface 121 and the second surface 122 and portions of the first side surface 126 and the second side surface 127 of the main body 12.

The first and second external electrodes 113 and 114 may each be made of a conductive material such as copper (Cu), aluminum (Al), silver (Ag), tin (Sn), gold (Au), nickel (Ni), lead (Pb), chromium (Cr), titanium (Ti), or an alloy thereof, but is not limited thereto.

The first and second external electrodes 113 and 114 may include a plurality of electrode layers. For example, the first and second external electrodes 113 and 114 may each include a first electrode layer, a second electrode layer that covers the first electrode layer, and a third electrode layer that covers the second electrode layer. The first electrode layer may include copper (Cu) and may be a conductive resin layer. The conductive resin layer may include a conductive metal for electrical conductivity and a resin for absorbing impact. The resin is not particularly limited as long as it has bonding and impact absorbing properties and can be mixed with conductive metal powder to make a paste, and may include, for example, phenol resin, acryl resin, silicone resin, epoxy resin, or polyimide resin. The conductive metal may include, for example, copper (Cu), tin (Sn), nickel (Ni), silver (Ag), palladium (Pd), gold (Au), platinum (Pt), tungsten (W), titanium (Ti), an alloy thereof, or a combination thereof.

Meanwhile, the first and second external electrodes 113 and 114 may each include a plurality of plating layers formed by plating a conductive metal.

The first external electrode 113 may include a first plating layer 1151, a second plating layer 1152, and a third plating layer 1153.

The first plating layer 1151 is a plating layer in contact with an outer surface of the main body 12 and may include copper (Cu). The second plating layer 1152 is a plating layer that covers the first plating layer 1151 and may include nickel (Ni). The third plating layer 1153 is a plating layer that covers the second plating layer 1152 and may include tin (Sn). However, the present embodiment is not limited to such a three-layer structure, and a two-layer structure in which only one plating layer is added above the first plating layer 1151 is also possible.

Referring to FIG. 4, before forming the first plating layer 1151, irregularities 125 may be formed by laser processing on the outer surface (for example the first surface 121) of the main body 12. When the irregularities 125 are formed on the first surface 121 of the main body 12, the surface roughness is increased such that the anchoring effect may become stronger. In other words, the increased surface area due to the presence of the irregularities may allow more conductive metal to adhere to the first surface 121, thereby strengthening the bond between the first surface 121 and the first plating layer 1151. After the first plating layer 1151 is formed, an additional plating layer (e.g., second plating layer 1152 or third plating layer 1153) that covers the first plating layer 1151 is formed to form the first external electrode 113. Since the first surface 121 of the main body 12 and the first plating layer 1151 are strongly bonded, the main body 12 and the first external electrode 113 can ultimately be strongly bonded. Therefore, according to the present embodiment, the risk of electrode peeling due to external forces can be reduced.

On the other hand, unlike the present embodiment, when the external electrode is made of silver (Ag)-epoxy, the above anchoring effect cannot be expected, and therefore a strong bond between the main body and the external electrode cannot be expected.

The second external electrode 114 may include a first plating layer 1161, a second plating layer 1162, and a third plating layer 1163.

The first plating layer 1161 is a plating layer in contact with an outer surface of the main body 12 and may include copper (Cu). The second plating layer 1162 is a plating layer that covers the first plating layer 1161 and may include nickel (Ni). The third plating layer 1163 is a plating layer that covers the second plating layer 1162 and may include tin (Sn). However, the present embodiment is not limited to such a three-layer structure, and a two-layer structure in which a tin (Sn) plating layer is formed on a copper (Cu) plating layer is also possible.

The same effect as with the first external electrode 113 can be achieved by forming irregularities by laser processing on the outer surface of the main body 12 before forming the first plating layer 1161 of the second external electrode 114.

As described, the first and second external electrodes 113 and 114 may each include nickel (Ni), copper (Cu), palladium (Pd), gold (Au), or an alloy thereof, and may include a plurality of plating layers. For example, the first and second external electrodes 113 and 114 may each be made of combinations such as nickel (Ni) layer, copper (Cu) layer, nickel/copper (Ni/Cu) layer, palladium/nickel (Pd/Ni) layer, palladium/nickel/copper (Pd/Ni/Cu) layer and copper/nickel/copper (Cu/Ni/Cu) layer.

In some embodiments, the outermost layer may be made of tin (Sn). Since the tin plating layer has a relatively low melting point, it can improve the ease of substrate mounting of the first and second external electrodes 113 and 114.

In general, the tin plating layer may be bonded to an electrode pad on a substrate through a solder including a tin (Sn)-copper (Cu)-silver (Ag) alloy paste. That is, the tin plating layer may melt and bond with the solder during the heat treatment (reflow) process.

Meanwhile, a separation distance L_{B} between the first external electrode 113 and the second external electrode 114 may be 45% or more and 70% or less of a length L₀ of the coil electronic component 100.

The separation distance L_{B} between the first external electrode 113 and the second external electrode 114 means a minimum distance between an edge of the first external electrode 113 and an edge of the second external electrode 114 facing in the length direction (L-axis direction) on a surface of the main body where the external electrodes are disposed.

A length L₀ of the coil electronic component 100 means a value including a thickness of an external electrode measured along the length direction (L-axis direction) of the main body 12 when the external electrodes are disposed on the first and second end surfaces 128 and 129 of the main body 12, and it means only a length of the main body 12 when the external electrode is not disposed on the first and second end surfaces 128 and 129 of the main body 12.

If the separation distance L_{B} between the first external electrode 113 and the second external electrode 114 is less than 45% of the length L₀ of the coil electronic component 100, the distance between external electrodes is too close and there is a risk of shorting.

If the separation distance L_{B} between the first external electrode 113 and the second external electrode 114 is greater than 70% of the length L₀ of the coil electronic component 100, the external electrode formation area is too small and the adhesion strength of the external electrode may be reduced.

The insulating layer 30 covers at least a part of an outer surface of the main body 12 between the first external electrode 113 and the second external electrode 114.

The insulating layer 30 covers the portions of the first and second surfaces 121 and 122 and the first and second side surfaces 126 and 127 of the main body 12, that are not covered by the first and second external electrodes 113 and 114.

The insulating layer 30 may include a thermoplastic resin such as polystyrene-based, vinyl acetate-based, polyester-based, polyethylene-based, polypropylene-based, polyamide-based, rubber-based, and acryl-based, a thermosetting resin such as phenol-based, epoxy-based, urethane-based, and melamine-based, and alkyd-based, a photosensitive resin, parylene, SiOₓ, or SiNₓ.

The insulating layer 30 may be formed by applying liquid insulating resin to the surface of the main body 12, laminating an insulating film such as dry film on the surface of the main body 12, or through a thin film process such as vapor deposition. For insulating film, it does not matter if an Ajinomoto build-up film (ABF) or polyimide film that does not contain photosensitive insulating resin is used.

A thickness T1 of the insulating layer 30 may be greater than 1 μm and smaller than 10 μm.

The thickness of the insulating layer 30 is measured on the basis of an optical microscope or scanning electron microscope (SEM) image of a cross-section (taken in the length direction (L-axis direction)-thickness direction (T-axis direction)) at a central portion of the coil electronic component 100 in the in the width direction (W-axis direction). The thickness of the insulating layer 30 may be an arithmetic mean value of the thicknesses of the insulating layer 30 at five equally spaced points on the insulating layer 30 of the coil electronic component 100 shown in the above-mentioned cross-sectional image. Meanwhile, the five points may be selected from a range excluding a range corresponding to 5% of the length of the insulating layer 30 from both ends in the length direction (L-axis direction) of the insulating layer 30, respectively.

Referring to FIGS. 3 and 4, the irregularities 125 may be disposed between the first surface 121 of the main body 12 and the insulating layer 30. For example, when the magnetic particle 123 that comprises the main body 12 protrudes from the resin 124, the irregularities may be formed. Considering the existence of irregularities, the minimum value of the thicknesses t1, t2, and t3 of the insulating layer 30 measured at three points on the first surface 121 is taken as the thickness T1 of the insulating layer 30.

There may be particularly thin portions in the part where the aforementioned irregularities 125 are formed, and these portions have a high probability of cracking due to external impact, so there is a risk of moisture penetration. In order to prevent such a problem, the thickness T1 of the insulating layer 30 is greater than 1 μm.

If the thickness T1 of the insulating layer 30 is 10 μm or more, under the condition that the size of the coil electronic component 100 is the same, the volume of the main body 12 decreases by that much, and thus a problem of not securing sufficient capacity may occur.

The thickness T1 of the insulating layer 30 may be smaller than the thickness of the first and second external electrodes 113 and 114. In other words, the thickness of the first and second external electrodes 113 and 114 may be greater than the thickness of the insulating layer 30. The difference G between the thickness of the insulating layer and the thickness of the first and second external electrodes may be greater than or equal to 5 μm and less than or equal to 15 μm.

If the difference G between the thickness of the first and second external electrodes 113 and 114 and the thickness of the insulating layer 30 is less than 5 μm, air trapping may occur or voids may be generated after underfilling during mounting of the substrate.

Meanwhile, if the difference G between the thickness of the first and second external electrodes 113 and 114 and the thickness of the insulating layer 30 exceeds 15 μm, a phenomenon in which the position of the coil electronic component is distorted, or one external electrode of the coil electronic component is fixed to the substrate while the other external electrode is separated from the substrate and stands up (Manhattan effect or Tombstone defect) may occur during mounting of the substrate.

FIG. 5 is a schematic cross-sectional view of the coil electronic component shown in FIG. 1 mounted on the substrate.

Referring to FIG. 5, the coil electronic component 100 is connected to a first electrode pad 711 and a second electrode pad 713 on an upper surface of the circuit board 700 through a conductive bonding member 715. That is, the coil electronic component 100 may be mounted on the circuit board 700 through the first and second electrode pads 711 and 713.

The first and second electrode pads 711 and 713 may be spaced apart from each other and disposed on the upper surface of the circuit board 700. The first and second external electrodes 113 and 114 of the coil electronic component 100 may be secured to the circuit board 700 using the conductive bonding member 715 while disposed to contact the first and second electrode pads 711 and 713. Accordingly, the coil electronic component 100 may be electrically connected to the first and second electrode pads 711 and 713 of the circuit board 700. The conductive bonding member 715 may include, for example, a solder.

In the present embodiment, each of the first and second external electrodes 113 and 114 of the coil electronic component 100 is mounted on the circuit board 700 by being fixed to the first and second electrode pads 711 and 713 by the conductive bonding member 715.

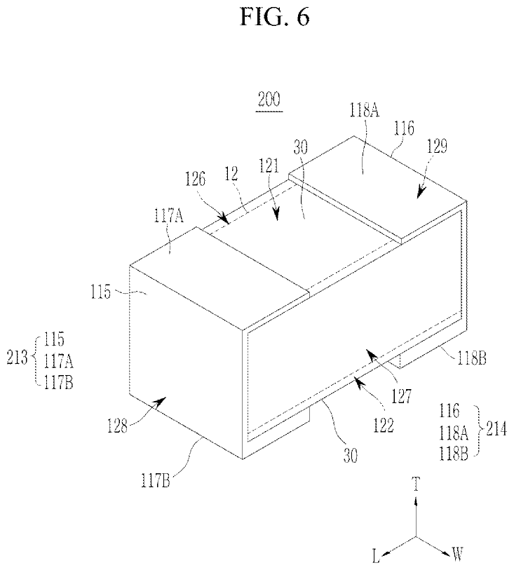

FIG. 6 is a schematic perspective view of a coil electronic component according to another embodiment.

Referring to FIG. 6, a first external electrode 213 of a coil electronic component 200 according to another embodiment extends to a first surface 121 and a second surface 122 from a first end surface 128 of a main body, and a second external electrode 114 extends to the first surface 121 and the second surface 122 from a second end surface 129 of the main body 12.

For example, the first external electrode 213 may include a first main portion 115 and first band portions 117A and 117B, and the second external electrode 214 may include a second main portion 116 and second band portions 118A and 118B.

An insulating layer 30 covers the first surface 121 of the main body 12 between the first band portion 117A and the second band portion 118A. On the other hand, since the first and second external electrodes 213 and 214 do not include band portions that cover first and second side surfaces 126 and 127 of the main body 12, the insulating layer 30 covers all of the first and second side surfaces 126 and 127 of the main body 12.

Except for the above, the remaining components are the same as the components of the coil electronic component shown in FIG. 1, and therefore a redundant description thereof will be omitted.

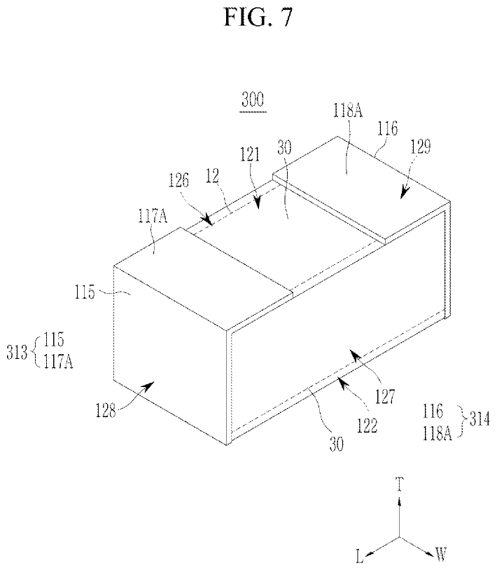

FIG. 7 is a schematic perspective view of a coil electronic component according to another embodiment.

Referring to FIG. 7, a first external electrode 313 of a coil electronic component 300 according to another embodiment extends to a first surface 121 from a first end surface 128 of a main body 12, and a second external electrode 114 extends to the first surface 121 from a second end surface 129 of the main body 12.

For example, the first external electrode 313 may include a first main portion 115 and a first band portion 117A, and the second external electrode 314 may include a second main portion 116 and a second band portion 118A.

The insulating layer 30 covers the first surface 121 of the main body 12 between the first band portion 117A and the second band portion 118A. Meanwhile, the first and second external electrodes 313 and 314 do not include a band portions that cover the second surface 122, a first side surface 126, and a second side surface 127 of the main body 12, the insulating layer 30 covers all of the second surface 122, the first side surface 126 and the second side surface 127 of the main body 12.

Except for the above, the remaining constituent elements are the same as the constituent element of the coil electronic component shown in FIG. 1, and therefore a redundant description thereof will be omitted.

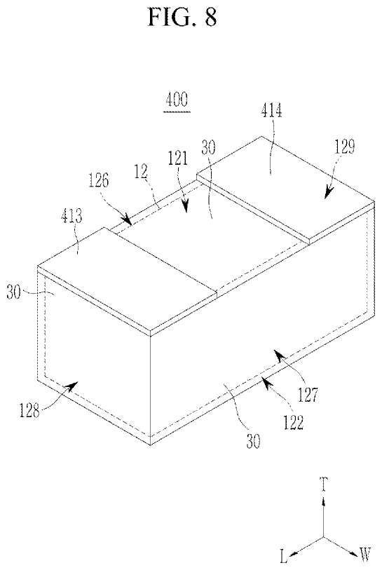

FIG. 8 is a schematic perspective view of a coil electronic component according to another embodiment.

Referring to FIG. 8, a first external electrode 413 and a second external electrode 414 of a coil electronic component 400 according to another embodiment are connected with a coil 150 (see FIG. 1) on a first surface 121 of a main body 12 and cover portions of the first surface 121. For example, the first external electrode 413 and the second external electrode 414 both may be disposed on the first surface 121 of the main body 12, and the second external electrode 414 may be opposed to the first external electrode 413 in the length direction (L-axis direction).

The insulating layer 30 covers the first surface 121 of the main body 12 between the first external electrode 413 and the second external electrode 414. Meanwhile, since the first and second external electrodes 413 and 414 do not include a band portions that cover first and second end surfaces 128 and 129, a second surface 122, a first side surface 126, and a second side surface 127 of the main body 12, the insulating layer 30 covers all of the first and second end surfaces 128 and 129, the second surface 122, the first side surface 126, and the second side surface 127 of the main body 12.

Except for the above, the remaining constituent elements are the same as the constituent element of the coil electronic component shown in FIG. 1, and therefore a redundant description thereof will be omitted.

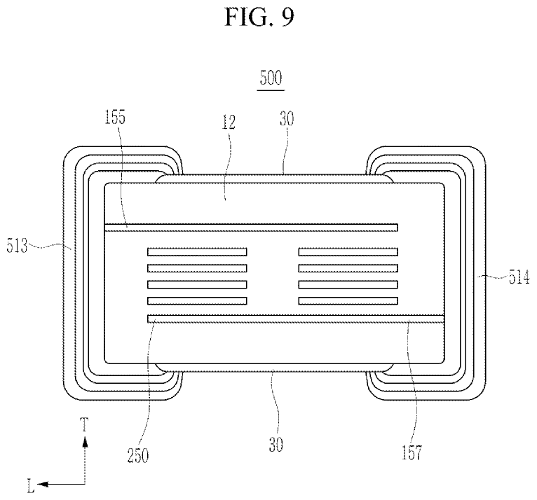

FIG. 9 is a schematic cross-sectional view of a coil electronic component according to another embodiment.

Referring to FIG. 9, a coil electronic component 500 includes a main body 12, a coil 250, first and second external electrodes 513 and 514, and an insulating layer 30.

The main body 12 may be a laminate in which a plurality of sheets (not shown) are stacked. The coil 250 may include a plurality of internal electrodes that is disposed on each sheet and connected to each other.

Both ends of the coil 250 are provided with lead terminals 155 and 157, respectively. The lead terminals 155 and 157 are parts where the coil 250 is electrically connected to the first and second external electrodes 513 and 514. The lead terminals 155 and 157 are exposed from a first end surface 128 and a second end surface 129 of the main body 12, respectively.

The first and second external electrodes 513 and 514 are disposed outside the main body 12 and are connected to the coil 250. The insulating layer 30 covers surfaces of the main body 12 between the first external electrode 513 and the second external electrode 514.

Except for the above, the remaining components are the same as the components of the coil electronic component shown in FIG. 1, and therefore a redundant description thereof will be omitted.

Meanwhile, the shape of the first and second external electrode may be the same as the shape shown in FIG. 6, FIG. 7, or FIG. 8.

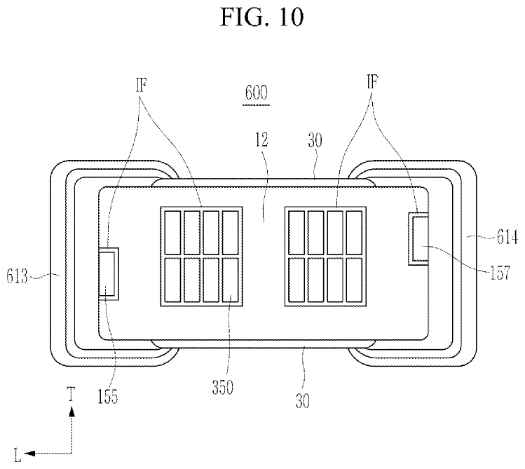

FIG. 10 is a schematic cross-sectional view of a coil electronic component according to another embodiment.

Referring to FIG. 10, a coil electronic component 600 includes a main body 12, a coil 350, first and second external electrodes 613 and 614, and an insulating layer 30.

The main body 12 includes a magnetic material, and may be made of magnetic particles and a thermosetting resin such as epoxy or polyimide interposed between magnetic particles.

The coil 350 is embedded in the main body 12 and exhibits the characteristics of the coil electronic component 600. The coil 350 is a wound coil, which may have a form in which a spiral wound of metal (e.g., copper (Cu) or silver (Ag)) wire with a surface covered with an insulating material.

The cross-section of the coil 350 may have various known shapes such as quadrangle, circle, and ellipse.

An insulating film IF may be disposed along a surface of each of a plurality of turns of the coil 350. The insulating film IF is to protect and insulate the plurality of turns of each coil 350, and may include a known insulating material such as parylene. Any insulating material may be included in the insulating film IF, and there are no specific limitations. The insulating film IF may be formed by a method such as vapor deposition, but is not limited thereto.

Both ends of the coil 350 are provided with lead terminals 155 and 157, respectively. The lead terminals 155 and 157 are parts where the coil 350 is exposed from a first end surface 128 and a second end surface 129 of the main body 12, respectively, and is electrically connected to the first and second external electrodes 613 and 614. No insulating film IF is present where the lead terminals 155 and 157 are connected to the first and second external electrodes 613 and 614.

The first and second external electrodes 613 and 614 are disposed outside the main body 12 and are connected to the coil 350. The insulating layer 30 covers one surfaces of the main body 12 between the first external electrode 613 and the second external electrode 614.

Except for the above, the remaining components are the same as the components of the coil electronic component shown in FIG. 1, and therefore a redundant description thereof will be omitted.

Meanwhile, the shape of the first and second external electrode may be the same as the shape shown in FIG. 6, FIG. 7, or FIG. 8.

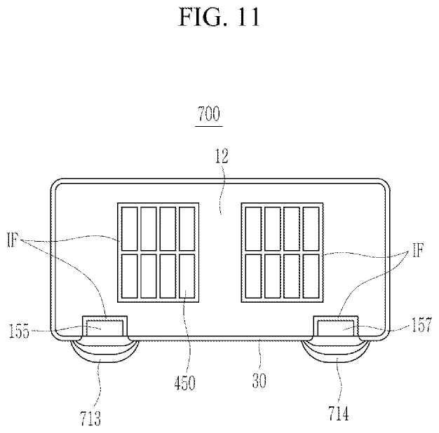

FIG. 11 is a schematic cross-sectional view of a coil electronic component according to another embodiment.

Referring to FIG. 11, a coil electronic component 700 includes a main body 12, a coil 450, first and second external electrodes 713 and 714, and an insulating layer 30.

The main body 12 includes a magnetic material, and may be made of magnetic particles and a thermosetting resin such as epoxy or polyimide interposed between the magnetic particles.

The coil 450 is embedded in the main body 12 and exhibits the characteristics of the coil electronic component 700. The coil 450 is a wound coil, which may have a form in which a spiral wound of metal (e.g., copper (Cu) or silver (Ag)) wire with a surface covered with an insulating material.

The cross-section of the coil 450 may have various known shapes such as quadrangle, circle, and ellipse.

An insulating film IF may be disposed along a surface of each of a plurality of turns of the coil 450. The insulating film IF is to protect and insulate the plurality of turns of each coil 450, and may include a known insulating material such as parylene. Any insulating material may be included in the insulating film IF, and there are no specific limitations. The insulating film IF may be formed by a method such as vapor deposition, but is not limited thereto.

Both ends of the coil 450 are provided with lead terminals 155 and 157, respectively. The lead terminals 155 and 157 are parts where the coil 450 is electrically connected to the first and second external electrodes 713 and 714. No insulating film IF is present where the lead terminals 155 and 157 are connected to the first and second external electrodes 713 and 714.

The first and second external electrodes 713 and 714 are disposed on the first surface 121 or second surface 122 of the main body 12 and are connected to the coil 450. The coil 450 extends toward the first surface 121 or the second surface 122 such that the lead terminals 155 and 157 of the coil 450 can be connected to the first and second external electrodes 713 and 714. The insulating layer 30 covers the first surface 121 or second surface 122 of the main body 12 between the first external electrode 713 and the second external electrode 714.

The insulating layer 30 may cover the entire outer surface of the main body 12 except for a portion where the lead terminals 155 and 157 of the coil 450 are exposed. The insulating layer may be formed by, for example, applying and curing an insulating material that includes an insulating resin to the surface of the main body 12. In this case, the insulating layer may include at least one of a thermoplastic resin such as polystyrene, vinyl acetate, polyester, polyethylene, polypropylene, polyamide, rubber, acryl-based, a thermosetting resin such as phenolic, epoxy, urethane-based, melamine, or alkyd, and photosensitive insulating resin

When the first and second external electrodes 713 and 714 are formed after the insulating layer 30 is formed on the main body 12, edges of the first and second external electrodes 713 and 714 may cover a portion of the insulating layer 30.

Except for the above, the remaining components are the same as the components of the coil electronic component shown in FIG. 1, and therefore a redundant description thereof will be omitted.

Hereinafter, detailed embodiments of the present disclosure will be disclosed. However, the embodiments described below are only intended to specifically illustrate or describe the invention, and the scope of the invention should not be limited thereto.

### [Manufacturing Example: Manufacturing of Coil Electronic Component]

### Embodiment 1

A coil electronic component in which a ratio of a separation distance of external electrodes to a length of the coil electronic component is 45% is manufactured.

### Embodiment 2

It is the same as Embodiment 1 except that the ratio of the separation distance of the external electrodes to the length of the coil electronic component is 50%.

### Embodiment 3

It is the same as Embodiment 1 except that the ratio of the separation distance of the external electrodes to the length of the coil electronic component is 55%.

### Embodiment 4

It is the same as Embodiment 1 except that the ratio of the separation distance of the external electrodes to the length of the coil electronic component is 60%.

### Embodiment 5

It is the same as Embodiment 1 except that the ratio of the separation distance of the external electrodes to the length of the coil electronic component is 65%.

### Embodiment 6

It is the same as Embodiment 1 except that the ratio of the separation distance of the external electrodes to the length of the coil electronic component is 70%.

### Comparative Example 1

It is the same as Embodiment 1 except that the ratio of the separation distance of the external electrodes to the length of the coil electronic component is 30%.

### Comparative Example 2

It is the same as Embodiment 1 except that the ratio of the separation distance of the external electrodes to the length of the coil electronic component is 35%.

### Comparative Example 3

It is the same as Embodiment 1 except that the ratio of the separation distance of the external electrodes to the length of the coil electronic component is 80%.

[Experimental Example: Shorting Rate of Coil Electronic Components and Whether the Coil Electronic Components have Poor Adhesion Strength or Not]

After manufacturing 30 pieces of each coil electronic components according to Embodiments 1 to 6 and Comparative Examples 1 to 3, respectively, the ratio of the separation distance between the external electrodes to the length of the coil electronic component was measured, and the shorting rate and adhesion strength of the external electrode were checked and the results are summarized in Table 1.

TABLE 1

| | The ratio [%] of the | | |
|---|---|---|---|
| | separation distance | | Whether the |
| | between external | | electronic |
| | electrodes to the length | | component has |
| | of the coil electronic | Shorting | poor adhesion |
| | component | rate | strength or not |
| Comparative | 30 | 3/30 | Good |
| Example 1 | | | |
| Comparative | 35 | 3/30 | Good |
| Example 2 | | | |
| Embodiment 1 | 45 | 0/30 | Good |
| Embodiment 2 | 50 | 0/30 | Good |
| Embodiment 3 | 55 | 0/30 | Good |
| Embodiment 4 | 60 | 0/30 | Good |
| Embodiment 5 | 65 | 0/30 | Good |
| Embodiment 6 | 70 | 0/30 | Good |
| Comparative | 80 | 0/30 | Poor |
| Example 3 | | | |

Referring to Table 1, in the coil electronic component manufactured in Embodiments 1 to 6, it can be confirmed that no shorts occurred because the separation distance between the external electrodes was sufficient relative to the length of the coil electronic component. The adhesion strength of the coil electronic components manufactured in Embodiments 1 to 6 was also good. In the coil electronic component manufactured in Comparative Examples 1 and 2, the shorting rate was higher than those in Embodiments 1 to 6. This is because the separation distance between external electrodes is too small relative to the length of the coil electronic component. However, the adhesion strength of the coil electronic component manufactured in Comparative Examples 1 to 2 was good. No shorts occurred in the coil electronic component manufactured in Comparative Example 3, because the separation distance between external electrodes relative to the length of the coil electronic component was larger than those in Comparative Examples 1 and 2. However, in the coil electronic component manufactured in Comparative Example 3, the adhesion strength was poor because the separation distance between external electrodes relative to the length of the coil electronic component is larger than those of Embodiments 1 to 6.

While the foregoing describes preferred embodiments of the present invention, it is to be understood that the invention is not limited thereto, and that various modifications are possible and fall within the scope of the claims, the description, and the accompanying drawings.

What is claimed is:

1. A coil electronic component comprising:
a main body that includes a first surface and a second surface opposing each other in a first direction, a third surface and a fourth surface connecting the first surface and the second surface and opposing each other in a second direction, and a fifth surface and a sixth surface connecting the first surface and the second surface and opposing each other in a third direction, and includes a magnetic material;
a coil disposed inside the main body;
a first external electrode and a second external electrode that are disposed at a distance from each other on the fifth surface or the sixth surface of the main body and respectively connected to opposite ends of the coil; and
an insulating layer that covers at least a portion of the fifth surface or sixth surface of the main body between the first external electrode and the second external electrode,
wherein a thickness of the insulating layer is greater than 1 μm and smaller than 10 μm.

2. The coil electronic component of claim 1, wherein:
a thickness of the first and second external electrodes is larger than the thickness of the insulating layer, and a difference in thickness therebetween is 5 μm or more and 15 μm or less.

3. The coil electronic component of claim 1, wherein:
a separation distance between the first external electrode and the second external electrode along the first direction is 45% or more and 70% or less of a length of the coil electronic component.

4. The coil electronic component of claim 1, wherein:
irregularities exist on the fifth surface or the sixth surface where the first external electrode and the second external electrode are disposed.

5. The coil electronic component of claim 4, wherein:
each of the first external electrode and the second external electrode comprises a first electrode layer that is in contact with the fifth surface or the sixth surface of the main body, a second electrode layer that covers the first electrode layer, and a third electrode layer that covers the second electrode layer.

6. The coil electronic component of claim 5, wherein:
the first electrode layer contains copper (Cu).

7. The coil electronic component of claim 6, wherein:
the first electrode layer includes a conductive resin layer.

8. The coil electronic component of claim 5, wherein:
the insulating layer is in contact with the first electrode layer of the first external electrode and the first electrode layer of the second external electrode.

9. The coil electronic component of claim 8, wherein:
the second electrode layer of the first external electrode and the second electrode layer of the second external electrode respectively cover end portions of the insulating layer in the first direction.

10. The coil electronic component of claim 9, wherein:
the second electrode layer of the first external electrode and the second electrode layer of the second external electrode respectively are in contact with the insulating layer.

11. The coil electronic component of claim 1, wherein:
the first external electrode is connected with the coil on the first surface, and extends to the fifth surface or the sixth surface, and
the second external electrode is connected with the coil on the second surface, and extends to the fifth surface or the sixth surface.

12. The coil electronic component of claim 1, wherein:
the first external electrode is connected with the coil on the first surface, and extends to the fifth surface and the sixth surface and,
the second external electrode is connected with the coil on the second surface, and extends to the fifth surface and the sixth surface.

13. The coil electronic component of claim 1, wherein:
the first external electrode is connected with the coil on the first surface, and extends to the third surface, the fourth surface, the fifth surface, and the sixth surface, and
the second external electrode is connected with the coil on the second surface, and extends to the third surface, the fourth surface, the fifth surface, and the sixth surface.

14. The coil electronic component of claim 1, further comprising a support substrate that includes a first support surface and a second support surface disposed inside the main body and opposing each other,
wherein the coil comprises:
a first coil disposed on the first support surface of the support substrate,
a second coil disposed on the second support surface of the support substrate, and
a via through the support substrate and connecting the first coil and the second coil.

15. The coil electronic component of claim 1, wherein:
the main body is a laminate made by stacking a plurality of sheets, and
the coil includes a plurality of internal electrodes that is disposed on each sheet of the plurality of sheets and connected to each other.

16. The coil electronic component of claim 1, wherein:
the coil is a wound coil.

17. The coil electronic component of claim 16, wherein:
the wound coil extends toward the fifth surface or the sixth surface, and a lead terminal of the wound coil is connected to one of the first external electrode and the second external electrode.
